(19) United States
(12) Patent Application Publication
(10) Pub. No.: US 2022/0358521 A1
(43) Pub. Date: Nov. 10, 2022

(54) MECHANISM TO ADD INSIGHTFUL INTELLIGENCE TO FLOWING DATA BY INVERSION MAPS

(71) Applicant: Rovi Guides, Inc., San Jose, CA (US)

(72) Inventors: Daina Emmanuel, Bangalore (IN); Padmassri Chandrashekar, Bangalore (IN); Reda Harb, Bellevue, WA (US)

(21) Appl. No.: 17/314,336

(22) Filed: May 7, 2021

(51) Int. Cl. G06Q 30/02; G06Q 50/00; G06F 16/23

(52) U.S. Cl. CPC G06Q 30/0201; G06Q 30/0204; G06Q 50/01; G06F 16/2379; G06F 40/40

(57) ABSTRACT

The present disclosure relates to determining the reliability of online content items using a non-linear data structure. More particularly, the present invention provides an effective tool for slowing down the spread of false or unreliable content online using a non-linear data structure. The present disclosure provides an algorithm that leverages content items available within the wider ecosystem associated with a root note to determine a content item's level of accuracy or reliability based on what is currently known about a topic or event associated with the content item.

### FIELD

The present disclosure relates to determining the reliability of online content items using a non-linear data structure. More particularly, the present invention provides an effective tool for slowing down the spread of false or unreliable content using a non-linear data structure.

### BACKGROUND

In today's world, there are innumerable sources of content and data. It is challenging to convert the vast amount of content, e.g., online content, into insightful information. This is especially the case in today's online ecosystem because there are many untrustworthy sources and authors. This results in a tremendous amount of fake news or unreliable interpretations of information being embedded into online spaces, e.g., social media platforms, which become difficult to distinguish from reliable content due to the quantum of data available. Therefore, the data that is constantly being uploaded onto the Internet and consumed by users may contain noise and false information, which spread quickly.

The generation of irrelevant or misinformative content can particularly be seen concerning any trending event or activity in the real or online world. There are times when content, e.g., news articles, goes viral simply because the article was viewed or retweeted or shared a high number of times in a short period. Such articles end can end up prioritized by automated systems in search results since they may be identified as “popular” or “interesting” by conventional online systems.

Although social networks have been developing algorithms to fight the spread of fake news, as this is considered a very serious issue in this digital age, currently, there are no indicators to warn users or content consumers that there is a high likelihood that an article may contain false information. Thus, there is a need for methods and systems that are capable of predicting the most relevant and/or reliable content items associated with a topic or an event.

### SUMMARY

According to a first aspect, a method is provided for determining the reliability of online content items using a non-linear data structure. The method comprises determining a root node of the non-linear data structure, wherein the root node comprises a content category and/or an event and receiving one or more source items and a plurality of content items for the non-linear data structure associated with the root node. The method further comprises determining a classification of each of the one or more source items, wherein the classification is based at least on a reliability of the one or more source items and storing each of the one or more source items to be represented by one of a plurality of source nodes of the non-linear data structure. The method further comprises assessing each of the plurality of content items against the one or more source items stored for the non-linear data structure, determining a confidence score of each of the plurality of content items based on the assessment, wherein the confidence score of each of the plurality of content items is indicative of each of the plurality of content item's reliability with respect to at least the one or more source items and storing each of the plurality of content items to be represented by one of a plurality of intermediary nodes of the non-linear data structure based on the confidence score of each of the plurality of content items, wherein each of the plurality of intermediary nodes are associated with one or more of the plurality of source nodes.

Accordingly, the present disclosure proposes an efficient algorithm to slow down the spread of wildly false or unreliable content online, e.g., on social media websites, and also a tool to warn users about facts relating to the content. For example, newly published articles may be passed through several processing stages and assigned a confidence value, which may be mapped onto a visual indicator, such as an odometer, to indicate to readers or users an estimate of the degree of reliability or accuracy of an article. In the present disclosure, the algorithm leverages content items associated with a given article, for example, already available within the wider ecosystem to determine a content item's level of accuracy or reliability based on what is currently known about a topic, event or category that the content item is associated with.

In some embodiments, in order to verify a content item's reliability, when the content item is input into the system, it may be first classified as unreliable or labelled as “fake”, for example. The system then implements embodiments described herein to prove whether the given content item is “relevant” or “irrelevant”, “reliable” or “unreliable”, “real” or “fake”, for example. The initially assumed “unreliable” content item, e.g., a news article, may or may not get refined during subsequent iterations of processes described herein in relation to assigning confidence scores to content items.

In some embodiments, the method further comprises receiving a new content item associated with the root node, assessing the new content item against the plurality of content items and the one or more source items stored for the non-linear data structure and determining a confidence score of the new content item based on the assessment, wherein the confidence score of the new content item is indicative of the new content item's reliability with respect to the plurality of content items and the one or more source items.

In some embodiments, the method further comprises storing the new content item for the non-linear data structure to be represented by one of the plurality of intermediary nodes based on the confidence score of the new content item. In some embodiments, at least one of the plurality of intermediary nodes is an empty node. In some embodiments, the step of storing the new content item comprises storing the new content item to be represented by the empty node.

In some embodiments, the method further comprises updating the non-linear data structure upon storing the new content item.

In some embodiments, the step of updating the non-linear data structure comprises updating the confidence score of each of the plurality of content items, wherein the updated confidence score is indicative of each of the plurality of content item's reliability with respect to at least the one or more source items and the new content item stored for the non-linear data structure.

In some embodiments, the method further comprises determining a displacement of each of the plurality of intermediary nodes with respect to the root node. In some embodiments, the displacement of each of the plurality of intermediary nodes correlates to the confidence score of each of the plurality of content items and the new content item associated with each of the plurality of intermediary nodes.

In some embodiments, the method further comprises determining a relevancy score for a user consuming one or more of the plurality of content items and/or the new content item.

In some embodiments, the method further comprises recommending one or more content items to the user based on the confidence score and/or relevancy score of each of the plurality of content items and the new content item.

In some embodiments, the method further comprises determining one or more groups comprising the user, wherein the relevancy score for the user is determined based on the one or more groups comprising the user.

In some embodiments, the one or more groups comprising the user is determined based on at least one of: a location of the user, an online community; an online platform; a social media platform; a friendship group; a workplace group; one or more content items viewed by the user; one or more content items liked by the user; and/or one or more content sources followed by the user.

In some embodiments, the method further comprises determining a status to each of the plurality of content items and the new content item, wherein the status is indicative of any of: true or false, factually correct or factually incorrect; disputed or undisputed; or relevant or irrelevant.

In some embodiments, the step of determining the status further comprises determining whether the confidence score of each of the plurality of content items and the new content item is above or below a predetermined threshold score.

In some embodiments, the method further comprises notifying the user consuming one or more of the plurality of content items and/or the new content item of the reliability of the one or more of the plurality of content items and/or the new content item using a notification for display.

In some embodiments, the notification comprises an indication of the confidence score of each of the plurality of content items and/or the new content item.

In some embodiments, the one or more source content items comprise content items from at least one of: a broadcast; a news provider; an online news platform; an online blog; a social media platform; and/or a group within the social media platform.

In some embodiments, the classification of each of the one or more source items is further based on at least one of: a popularity; a quality; a level of professionalism; researched public sentiment; a number of views; a number of followers; a number of likes; a source; an author; a historical classification of the source; a historical classification of the author; one or more similar source items; one or more associated source items; and/or historically classified source items.

In some embodiments, the confidence score of each of the plurality of content items and the confidence score of the new content item is further based on at least one of: a popularity; a quality; a level of professionalism; researched public sentiment; a number of views; a number of followers; a number of likes; a source; an author; a historical classification of the source; a historical classification of the author; one or more similar source items; one or more associated source items; confidence scores of one or more associated content items; a location of its viewers; a link; a reference; and/or a relevance to a verified content item.

It will be appreciated that other features, aspects and variations of the present invention will be apparent from the disclosure herein of the drawings and detailed description. Additionally, it will be further appreciated that additional or alternative embodiments may be implemented within the principles set out by the present disclosure.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 shows an illustrative depiction of an example user device, in accordance with some embodiments of the present disclosure;

FIG. 2 shows a block diagram of an illustrative user equipment system, in accordance with some embodiments of the present disclosure;

FIG. 3 is an illustrative block diagram showing a system having a plurality of data structures, in accordance with some embodiments of the disclosure;

FIG. 4 shows an example data structure, in accordance with various embodiments described herein;

FIG. 5 is a flowchart of illustrative steps involved in creating a data structure and determining confidence scores for content items associated with the data structure in a way that indicates the content item's reliability based on various source content items, in accordance with some embodiments of the present disclosure;

FIG. 6 is a flowchart of illustrative steps involved in updating a data structure and determining confidence scores for new or additional content items associated with the data structure in a way that indicates the content item's reliability based on various source content items and/or content items currently represented in the data structure, in accordance with some embodiments of the present disclosure;

FIG. 7 is a flowchart of illustrative steps of an example implementation of some embodiments of the present disclosure for determining a confidence scoring process for a content item as part of a trending topic or event;

FIG. 8A is a flowchart of illustrative steps involved in determining the status of content items based on their confidence scores and a predetermined threshold setting suitable for labelling the content item with a negative or a positive status, in accordance with some embodiments of the present disclosure;

FIG. 8B is a flowchart of illustrative steps involved in recommending content items to users based on knowledge of the user, such as any groups associated with the user, and the determined confidence scores of the content items; and

FIG. 9 shows an illustrative diagram of an example user interface comprising a visual indicator representing the status of content items, in accordance with some embodiments of the present disclosure.

The figures herein depict various embodiments of the disclosed invention for purposes of illustration only. It will be appreciated that additional or alternative structures, systems and methods may be implemented within the principles set out by the present disclosure.

### DETAILED DESCRIPTION

As referred to herein, a “media guidance application” or a “guidance application” is an application that provides media guidance data to a user through an interface. For example, a media guidance application may allow users to efficiently navigate content selections and easily identify content that they may desire. The media guidance application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (RAM), etc.

As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

As referred to herein, the terms “media asset” and “media content” should be understood to mean an electronically consumable user asset, such as a live televise program, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate and locate content.

As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smartphone, or any other television equipment, computing equipment, or wireless device, and/or combination of the same.

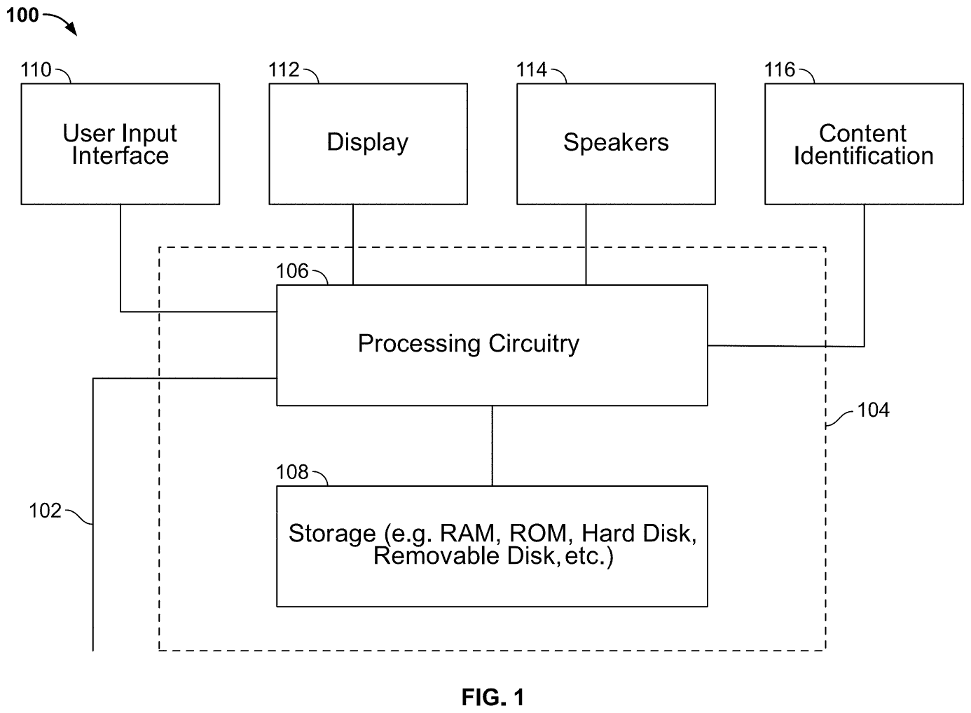

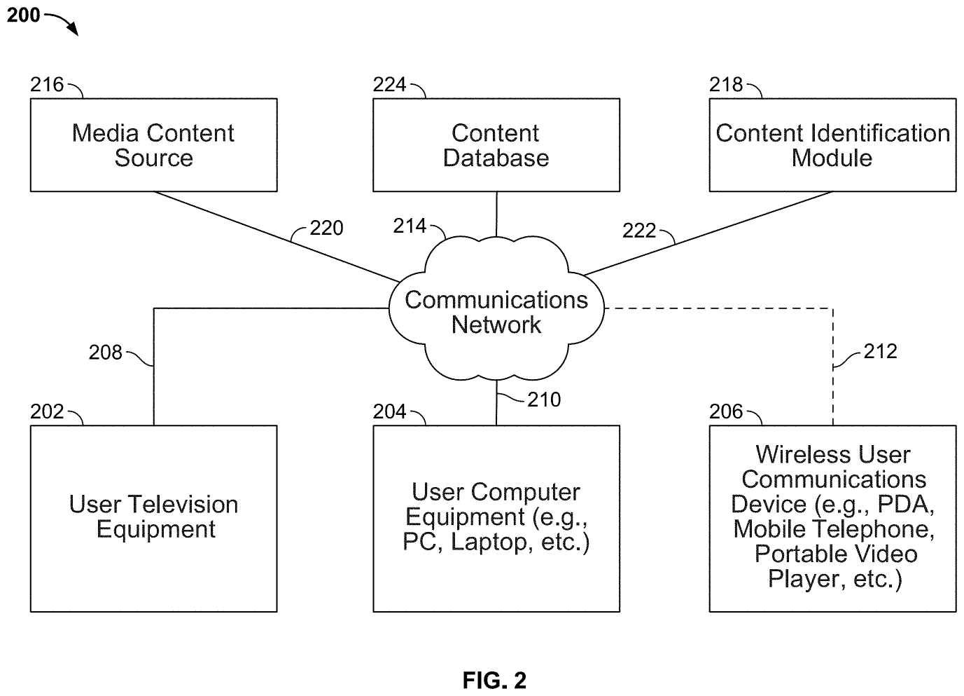

Users may access content and the media guidance application (and its display screens described above and below) from one or more of their user equipment devices. FIG. 1 shows a generalized embodiment of illustrative user equipment device 100. More specific implementations of user equipment devices are discussed below in connection with FIG. 2. User equipment device 100 may receive content and data via input/output (hereinafter “I/O”) path 102. I/O path 102 may provide content (e.g., broadcast programming, on-demand programming, Internet content, content available over a local area network (LAN) or wide area network (WAN), and/or other content) and data to control circuitry 104, which includes processing circuitry 106 and storage 108. Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1 to avoid overcomplicating the drawing.

Control circuitry 104 may be based on any suitable processing circuitry such as processing circuitry 106. As referred to herein, processing circuitry should be understood to mean circuitry based on one or more microprocessors, microcontrollers, digital signal processors, programmable logic devices, field programmable gate arrays (FPGAs), application-specific integrated circuits (ASICs), etc., and may include a multi-core processor (e.g., dual-core, quad-core, hexacore, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 104 executes instructions for a media guidance application stored in memory (i.e., storage 108). Specifically, control circuitry 104 may be instructed by the media guidance application to perform the functions discussed above and below. For example, the media guidance application may provide instructions to control circuitry 104 to generate the media guidance displays. In some implementations, any action performed by control circuitry 104 may be based on instructions received from the media guidance application.

In client-server based embodiments, control circuitry 104 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 2). In addition, communications circuitry may include circuitry that enables peer-to-peer communication of user equipment devices, or communication of user equipment devices in locations remote from each other.

Memory may be an electronic storage device provided as storage 108 that is part of control circuitry 104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 108 may be used to store various types of content described herein as well as media guidance data described above. Nonvolatile memory may also be used (e.g., to launch a boot-up routine and other instructions). Cloud-based storage, described in relation to FIG. 2, may be used to supplement storage 108 or instead of storage 108.

Control circuitry 104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 104 may also include scaler circuitry for upconverting and downconverting content into the preferred output format of the user equipment 100. Circuitry 104 may also include digital-to-analog converter circuitry and analog-to-digital converter circuitry for converting between digital and analog signals.

The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 108 is provided as a separate device from user equipment 100, the tuning and encoding circuitry (including multiple tuners) may be associated with storage 108.

A user may send instructions to control circuitry 104 using user input interface 110. User input interface 110 may be any suitable user interface, such as a remote control, mouse, trackball, keypad, keyboard, touchscreen, touchpad, stylus input, joystick, voice recognition interface, or other user input interfaces.

Display 112 may be provided as a stand-alone device or integrated with other elements of user equipment device 100. For example, display 112 may be a touchscreen or touch-sensitive display. In such circumstances, user input interface 112 may be integrated with or combined with display 112. Display 112 may be one or more of a monitor, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images.

In some embodiments, display 112 may be HDTV-capable. In some embodiments, display 112 may be a 3D display, and the interactive media guidance application and any suitable content may be displayed in 3D. A video card or graphics card may generate the output to the display 112. The video card may offer various functions such as accelerated rendering of 3D scenes and 2D graphics, MPEG5 2/MPEG-4 decoding, TV output, or the ability to connect multiple monitors. The video card may be any processing circuitry described above in relation to control circuitry 104. The video card may be integrated with the control circuitry 104. Speakers 114 may be provided as integrated with other elements of user equipment device 100 or may be stand-alone units. The audio component of videos and other content displayed on display 112 may be played through speakers 114. In some embodiments, the audio may be distributed to a receiver (not shown), which processes and outputs the audio via speakers 114. User equipment device 100 may also incorporate or be accessible to one or more other modules 116. For example, a content identification module 116 for identifying visual content, for example.

The media guidance application may be implemented using any suitable architecture. For example, it may be a stand-alone application wholly-implemented on user equipment device 100. In such an approach, instructions of the application are stored locally (e.g., in storage 108), and data for use by the application is downloaded on a periodic basis (e.g., from an out-of-band feed, from an Internet resource, or using another suitable approach). Control circuitry 104 may retrieve instructions of the application from storage 108 and process the instructions to generate any of the displays discussed herein. Based on the processed instructions, control circuitry 104 may determine what action to perform when input is received from input interface 110. For example, movement of a cursor on a display up/down may be indicated by the processed instructions when input interface 110 indicates that an up/down button was selected.

In some embodiments, the media guidance application is a client-server based application. Data for use by a thick or thin client implemented on user equipment device 100 is retrieved on-demand by issuing requests to a server remote to the user equipment device 100. In one example of a client-server based guidance application, control circuitry 104 runs a web browser that interprets web pages provided by a remote server. For example, the remote server may store the instructions for the application in a storage device. The remote server may process the stored instructions using circuitry (e.g., control circuitry 104) and generate the displays discussed above and below.

The client device may receive the displays generated by the remote server and may display the content of the displays locally on equipment device 100. This way, the processing of the instructions is performed remotely by the server while the resulting displays are provided locally on equipment device 100. Equipment device 100 may receive inputs from the user via input interface 110 and transmit those inputs to the remote server for processing and generating the corresponding displays. For example, equipment device 100 may transmit a communication to the remote server indicating that an up/down button was selected via input interface 110. The remote server may process instructions in accordance with that input and generate a display of the application corresponding to the input (e.g., a display that moves using a cursor up/down). The generated display is then transmitted to equipment device 100 for presentation to the user.

In some embodiments, the media guidance application is downloaded and interpreted or otherwise run by an interpreter or virtual machine (run by control circuitry 104). In some embodiments, the guidance application may be encoded in the ETV Binary Interchange Format (EBIF), received by control circuitry 104 as part of a suitable feed, and interpreted by a user agent running on control circuitry 104. For example, the guidance application may be an EBIF application. In some embodiments, the guidance application may be defined by a series of JAVA-based files that are received and run by a local virtual machine or other suitable middleware executed by control circuitry 104. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 100 of FIG. 1 can be implemented in system 200 of FIG. 2 as user television equipment 202, user computer equipment 204, wireless user communications device 206, or any other type of user equipment suitable for accessing content. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 1 may not be classified solely as user television equipment 202, user computer equipment 204, or a wireless user communications device 206. For example, user television equipment 202 may, like some user computer equipment 204, be Internet-enabled allowing for access to Internet content, while user computer equipment 204 may, like some television equipment 202, include a tuner allowing for access to television programming. The media guidance application may have the same layout on various different types of user equipment or may be tailored to the display capabilities of the user equipment. For example, on user computer equipment 204, the guidance application may be provided as a web site accessed by a web browser. In another example, the guidance application may be scaled down for wireless user communications devices 206.

In system 200, there may be more than one of each type of user equipment device but only one of each is shown in FIG. 2 to avoid overcomplicating the drawing. In addition, each user may utilize more than one type of user equipment device and also more than one of each type of user equipment device. In some embodiments, a user equipment device (e.g., user television equipment 202, user computer equipment 204, wireless user communications device 206) may be referred to as a “second screen device” or “secondary device”.

The user may also set various settings to maintain consistent media guidance application settings, e.g., volume settings, across in-home devices and remote devices. Settings include programming preferences that the guidance application utilizes to make programming recommendations, display preferences, and other desirable guidance settings. For example, if a user sets a preferred volume level as a favorite volume level on, for example, a web site mobile phone, the same settings would appear on the user's in-home devices (e.g., user television equipment and user computer equipment), if desired. Therefore, changes made on one user equipment device can change the guidance experience on another user equipment device, regardless of whether they are the same or a different type of user equipment device.

The user equipment devices may be coupled to communications network 214. Namely, user television equipment 202, user computer equipment 204, and wireless user communications device 206 are coupled to communications network 214 via communications paths 208, 210, and 212, respectively. Communications network 214 may be one or more networks including the Internet, a mobile phone network, mobile voice or data network (e.g., a 4G or LTE network), cable network, public switched telephone network, or other types of communications network or combinations of communications networks. Paths 208, 210, and 212 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths.

Path 212 is drawn with dotted lines to indicate that in the exemplary embodiment shown in FIG. 2 it is a wireless path and paths 208 and 210 are drawn as solid lines to indicate they are wired paths (although these paths may be wireless paths, if desired). Communications with the user equipment devices may be provided by one or more of these communications paths, but are shown as a single path in FIG. 2 to avoid overcomplicating the drawing.

Although communications paths are not drawn between user equipment devices, these devices may communicate directly with each other via communication paths, such as those described above in connection with paths 208, 210, and 212, as well as other short-range point-to-point communication paths, such as USB cables, IEEE 1394 cables, wireless paths (e.g., Bluetooth, infrared, IEEE 702-11x, etc.), or other short-range communication via wired or wireless paths. BLUETOOTH is a certification mark owned by Bluetooth SIG, INC. The user equipment devices may also communicate with each other directly through an indirect path via communications network 214.

System 200 includes content source 216 and media guidance data source 218 coupled to communications network 214 via communication paths 220 and 222, respectively. Paths 220 and 222 may include any of the communication paths described above in connection with paths 208, 210, and 212. Communications with the content source 216 and media guidance data source 218 may be exchanged over one or more communications paths, but are shown as a single path in FIG. 2 to avoid overcomplicating the drawing. In addition, there may be more than one of each of content source 216 and media guidance data source 218, but only one of each is shown in FIG. 2 to avoid overcomplicating the drawing. (The different types of each of these sources are discussed below.) If desired, content source 216 and media guidance data source 218 may be integrated as one source device. Although communications between sources 216 and 218 with user equipment devices 202, 204, and 206 are shown as through communications network 214, in some embodiments, sources 216 and 218 may communicate directly with user equipment devices 202, 204, and 206 via communication paths (not shown) such as those described above in connection with paths 208, 210, and 212.

Content source 216 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 216 may be the originator of content (e.g., a television broadcaster, a Webcast provider, etc.) or may not be the originator of content (e.g., an on-demand content provider, an Internet provider of content of broadcast programs for downloading, etc.). Content source 216 may include cable sources, satellite providers, on-demand providers, Internet providers, over-the-top content providers, or other providers of content. Content source 216 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 218 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Media guidance applications may be, for example, stand-alone applications implemented on user equipment devices. For example, the media guidance application may be implemented as software or a set of executable instructions which may be stored in storage 108, and executed by control circuitry 104 of a user equipment device 100. In some embodiments, media guidance applications may be client-server applications where only a client application resides on the user equipment device, and server application resides on a remote server. For example, media guidance applications may be implemented partially as a client application on control circuitry 104 of user equipment device 100 and partially on a remote server as a server application (e.g., media guidance data source 218) running on control circuitry of the remote server. When executed by control circuitry of the remote server (such as media guidance data source 218), the media guidance application may instruct the control circuitry to generate the guidance application displays and transmit the generated displays to the user equipment devices. The server application may instruct the control circuitry of the media guidance data source 218 to transmit data for storage on the user equipment. The client application may instruct control circuitry of the receiving user equipment to generate the guidance application displays.

Content and/or media guidance data delivered to user equipment devices 202, 204, and 206 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT. In addition to content and/or media guidance data, providers of OTT content can distribute media guidance applications (e.g., web-based applications or cloud-based applications), or the content can be displayed by media guidance applications stored on the user equipment device.

Media guidance system 200 is intended to illustrate various approaches, or network configurations, by which user equipment devices and sources of content and guidance data may communicate with each other for the purpose of accessing content and providing media guidance. The embodiments described herein may be applied in any approach that does not deviate from the teachings of this disclosure, for example in a system employing an approach for delivering content and providing media guidance.

In an example approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 214. These cloud resources may include one or more content sources 216 and one or more media guidance data sources 218. In addition or in the alternative, the remote computing sites may include other user equipment devices, such as user television equipment 202, user computer equipment 204, and wireless user communications device 206. For example, the other user equipment devices may provide access to a stored copy of a video or a streamed video.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 1.

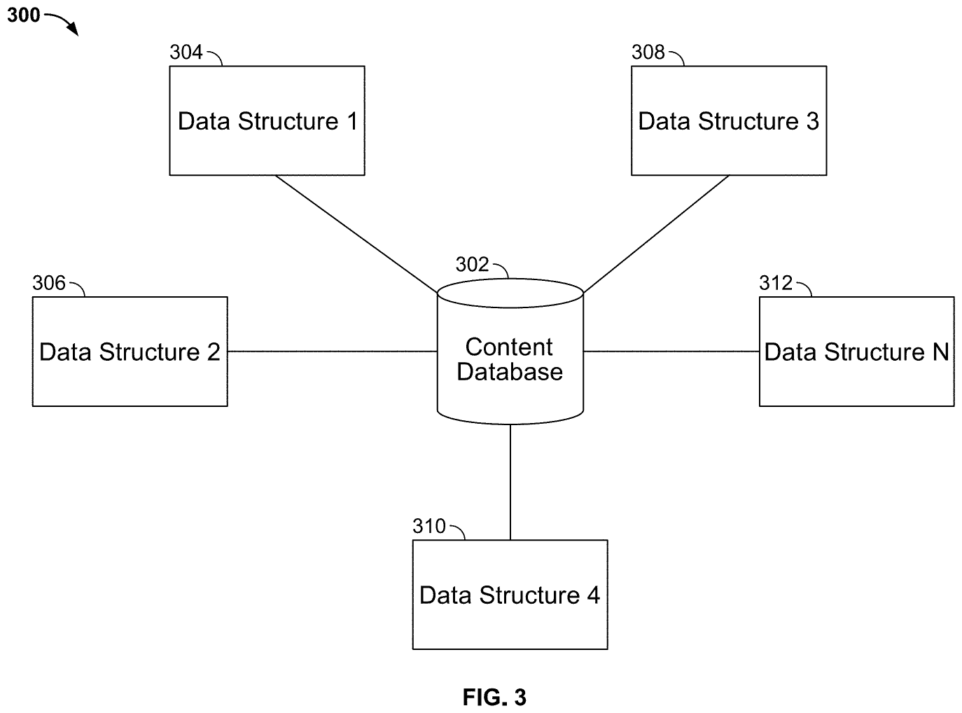

As shown in the example of FIG. 3, there may be more than one of each type of data structure, e.g., data structures 1 to N as shown in FIG. 3 as 304, 306, 308, 310 and 312 for illustration purposes only, all connected to a content database 302. Data structures may additionally be connected to one or more other content databases.

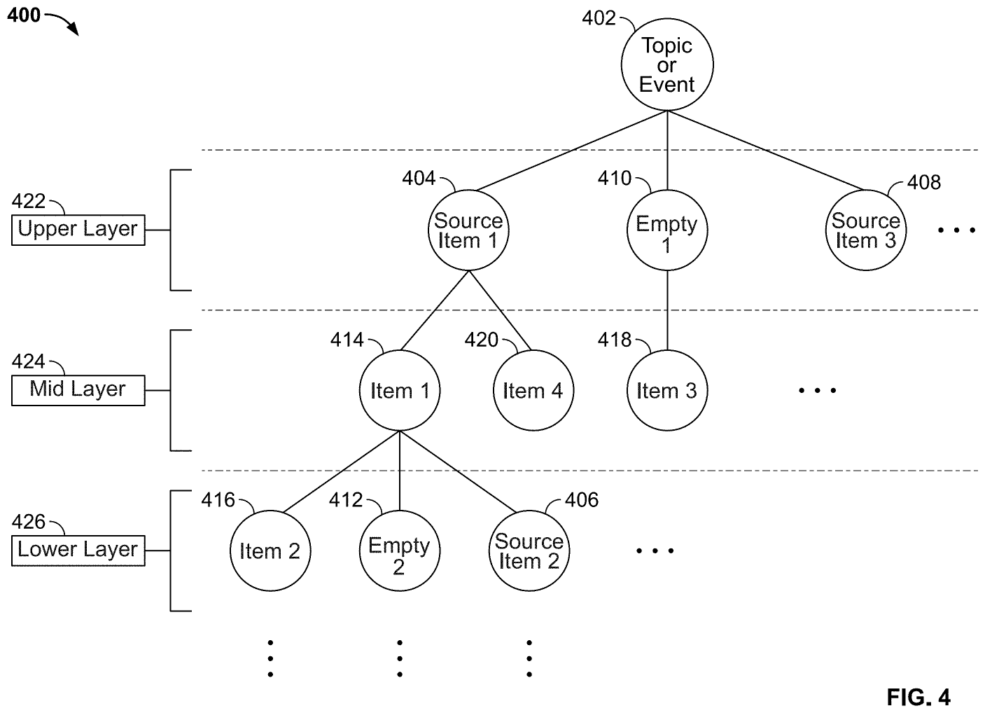

FIG. 4 shows an example data structure, in accordance with various embodiments described herein. Only one example data structure is shown in FIG. 4 for illustration purposes only and to avoid overcomplicating the drawing. Furthermore, it will be appreciated that FIG. 4 is a further simplification of a data structure, and it will be appreciated that any other non-linear data structure may be implemented without diverting from the teachings of the present disclosure, e.g., a graph data structure.

An example tree data structure is shown in FIG. 4. A tree, as it is known in the art, is a collection of data items typically represented as nodes and is a non-linear data structure that arranges data items in sorted order, e.g., by arranging content items in order of relevance or reliability. Such a data structure can be used to understand a hierarchical structure between various data elements and organize the data into branches that relate the information of various content items. There are several types of tree data structures, such as a binary tree, binary search tree, AVL, tree, threaded binary tree, B-tree, etc., any of which may be implemented in relation to embodiments described herein without diverting from the teachings of the present disclosure.

There are various terms known in the art that are associated with tree data structures and, in the context of the present disclosure, any suitable term may be used. In the example of FIG. 4, a topic or an event 402 is provided as a root node or root element of data structure 400. The data structure may comprise any number of source items or source content items 404, 406, 408, items or content items 414, 416, 418, empty nodes 410, 412, and multiple layers or levels 422, 424, 426, as will be described in more detail below. Each of the nodes (source nodes, root node and other intermediary nodes, such as empty nodes) may be connected with one or more other nodes by links or edges.

The digital world is constantly being bombarded with unstructured data, and one effective way to understand and verify content is to use artificial intelligence algorithms and tools. Unstructured data is all around us. For example, mass amounts of unstructured data can be seen on social media platforms, chatting platforms, websites, etc. Although the online world has created a data-rich and content-rich environment, trying to derive insights, such as determining whether a particular content item is reliable or factually correct, can be particularly difficult and time-consuming due to content items' unstructured nature and the required level of analysis, organizing and filtering involved.

In view of the foregoing, the present disclosure proposes an efficient and effective algorithm that may be used to slow down the spread of false or unreliable content, e.g., on social media websites, and also provides a tool that may warn users about facts relating to content items. For example, a newly published article may be passed through several processing stages and assigned a confidence value, which may be mapped onto a visual indicator, e.g., an odometer, to indicate to readers or users an estimated degree of reliability or accuracy of the article. In the present disclosure, the algorithm may leverage source items and content items associated with a given event or topic already available within the wider ecosystem to determine a new content item's level of accuracy or reliability based on what is currently known about the topic or event.

In some embodiments, in order to verify a content item's level of reliability, when the content item is input into the algorithm, it may be initially classified as unreliable or labelled as “fake,” for example. The system may then implement embodiments described herein to prove whether the given content item is “relevant” or “irrelevant,” “reliable” or “unreliable,” “real” or “fake,” for example. The initially assumed “unreliable” content item may or may not get refined through the various processes described herein.

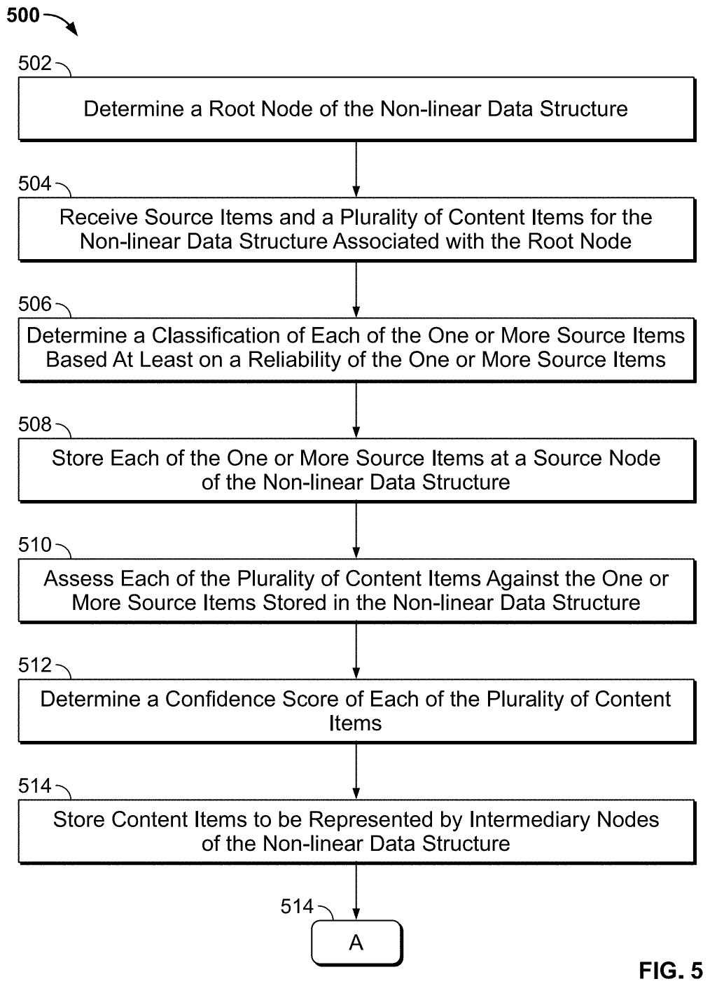

FIG. 5 is a flowchart of illustrative steps involved in creating a non-linear data structure and determining confidence scores for content items associated with the data structure in a way that indicates the content item's reliability based on knowledge of source items, in accordance with some embodiments of the present disclosure. In addition, one or more steps of process 500 may be incorporated into or combined with one or more steps of any other process or embodiment disclosed herein.

At step 502, the system determines a root node or root element for the data structure. In example embodiments, the root node of the data structure may represent a content category, a sub-category, a topic and/or an event or any combination thereof. In some embodiments, determining the root node may rely on existing natural language processing technologies, such as supervised machine-learning algorithms that can classify documents.

Categorization or classification of content items may be carried out in various ways. For example, for textual content, e.g., an article, the information embedded within the article may be classified by methods such as document classification and/or textual classification. It will be appreciated that other content items may also be classified in their own appropriate ways. For example, media content, such as an audio broadcast or a video, may be classified using content identification techniques. In classifying content items, content identification, audio identification and/or any other suitable method of content classification may be implemented in order to categorize/classify the media content.

Content classification in the context of this disclosure may be understood as annotating, labeling or tagging of content items or segments of content items using content categories, sub-categories, topics and/or events, based on the information embedded within the content items. It will be appreciated that any automated or semi-automated method, powered by natural language processing and machine learning algorithms, may be implemented for content classification.

Textual classification in the context of this disclosure may be understood as performing analysis techniques on text-based content items. Textual classification methods may be implemented at a document-level, paragraph-level, sentence-level, and/or sub-sentence level, depending on the type of content, length and/or content information, for example. In some embodiments, a combination of textual classification methods may be implemented for cases where an article contains information relating to more than one category or event. It will be appreciated that any automated or semi-automated methods, powered by natural language processing and machine learning algorithms, for example, rule-based classification, machine learning-based classifications and/or hybrid systems, may be implemented in text classification to analyze and categorize content items. For example, any of the following textual classification algorithms may be used: Naïve Bayes family of algorithms, support vector machines, deep learning convolutional neural networks and/or deep learning recurrent neural networks.

In some embodiments, one or more content classification methods may be implemented within the scope of the present disclosure. A high-level content classification may be carried out in order to paint a picture of the overarching category of a given content item, and more in-depth classifications may be carried out to process paragraphs, sentences and sub-sentences to gain a deeper insight into specific sub-categories, events, persons, characters or opinions the content item discloses, for example. Content classification may be supervised, unsupervised or rules-based, for example, and may classify content into one or more categories.

In example embodiments, the content classification may be carried out using any one or a combination of techniques, e.g., triaging, content identification and/or analytics. It will be appreciated that any other suitable content classification technique may be implemented during the content classification process described herein. Triaging may be useful in the sorting of content items; identification may be useful in identifying content items with different languages, genres, topics or demographic targets; and analytics may be useful in monitoring currently trending topics or events, for example.

At step 504, the system receives source content items and a plurality of other content items for the non-linear data structure associated with the category, topic and/or event, which is represented by and associated with the root node in the data structure. Typically, all content items may be categorized to be in the same category as the root node or categorized to be in an adjacent category to be represented within the same data structure.

For example, source content items may be received from any of a broadcast, a news provider, an online news platform, an online blog, a social media platform, and/or a group within the social media platform. Sources can also include shows on cable TV networks, radio shows, national newspapers, as well as digital news outlets that syndicate content from a plurality of sources. Source content items may be content items generated by reputed outlets of information and/or sources that are defined to be “reliable,” “unreliable,” etc.

The plurality of other content items for the data structure may be received from any of a broadcast, a news provider, an online news platform, an online blog, a social media platform, and/or a group within the social media platform. Content items can also include shows on cable TV networks, radio shows, national newspapers, as well as digital news outlets. Content items may be retrieved from any outlet of information and may include online posts by users, for example. It will be appreciated that content items may be differentiated from source content items by any of the following: upload time, source, and/or content platforms. For example, source items may be content items that were uploaded first and/or generated from sources of a defined level of reliability, and other content items may be content items that are uploaded at a later point in time and/or generated from sources of an undefined level of reliability. Content items may also be related to the source that has generated the source items, and thus be associated with source items in this way.

At step 506, the system determines a classification of each of the source content items based at least on reliability. In some embodiments described herein, source items, e.g., news articles, can play an important role in the initial creation of the data structure for determining the reliability of other content items received at the data structure. In example embodiments, a classification may be determined for each source content item based at least on the reliability of its source. For example, in some embodiments, various sources may be initially classified into classifications such as “trusted,” “mostly reliable,” “reliable,” “popular and reliable,” “popular and unreliable,” “amateur,” “professional,” etc. In some embodiments, the classification of each of the source items may be further based on at least one of a popularity, a quality, a level of professionalism, researched public sentiment, a number of views, a number of followers, a number of likes, a source, an author, a historical classification of the source, a historical classification of the author, one or more similar source items, one or more associated source items, and/or historically classified source items.

The assessment of the source content items may be carried out using any of the aforementioned content classification methods or any other suitable method known in the art. Using knowledge of the source items, further content items received at the data structure may be assessed to determine or evaluate the status of an event or a confidence level indicative of a content item's reliability, accuracy or relevance, for example.

Based on each content item's association with the root node, source items and content items may be represented as child nodes of the root node in the data structure, described as source nodes (representing source items) and intermediary nodes (representing other content items) for purposes of illustration only.

At step 508, the system stores each source item to be represented by a source node of the non-linear data structure. In example embodiments, the initial placement/node location representing each source content item may correlate with the classification of the source item. Thus, the initial placement/classification of source items in the non-linear data structure may be based on a variety of data, such as researched public sentiment, the average number of viewers of a show and/or TV channel, historical ratings, etc.

At step 510, the system assesses each of the plurality of content items against the stored source items represented by source nodes in the non-linear data structure relating to the same root node.

At step 512, the system determines a confidence score of each of the plurality of content items. In example embodiments, a confidence score is determined for each of the plurality of content items based on the assessment of each of the content items against the source content item. The confidence score may be indicative of each content item's reliability, accuracy or relevance with respect to at least one of the source items in the data structure. For example, if a first source content item and a second source content item are represented by first and second source nodes, respectively, and a content item received is analyzed and classified to be more closely related to the first source item, a confidence score may be assigned to the content item indicative of the relationship between the content item and the first and second source items and their classifications of reliability.

In some embodiments, content items, e.g., articles, may be analyzed and scored based on any one or a combination of: context, a popularity, a quality, a level of professionalism, researched public sentiment, a number of views, a number of followers, a number of likes, a source, an author, a historical classification of the source, a historical classification of the author, one or more similar source items, one or more associated source items, confidence scores of one or more associated content items, a location of its viewers, a link, a reference, and/or a relevance to a verified content item. In this way, a standardized method of determining a confidence score can be provided that may be implemented for all content items input into the system, assigning a confidence score to a content item based on its source, content information and/or activities surrounding it. For example, activity related to an article on a social network may include the number of times the article was shared, the length of the article, the reading time of the article, the number of people who commented on the article, etc. For example, the location of social network users who commented on the article may also contribute to the scoring of the content item. For example, a short article about U.S. politics relating to a specific U.S. state, e.g., New York, that gets retweeted or liked by people in a different region, e.g., Europe, may be less likely to be a strong indicator of the reliability of the article compared to activity of U.S. users from that specific U.S. state. Thus, in some embodiments, one or more factors associated with determining the confidence score may be weighted in order to provide a robust and scalable method of accurately assessing the reliability or accuracy of content items.

At step 514, the process stores content items to be represented by intermediary nodes of the non-linear data structure. For example, each content item may be stored in the database for the data structure and represented by suitably placed intermediary nodes based on each of their assigned confidence scores. For example, a content item closely relating to a particular source item may be represented by an intermediary node that is associated with the source node representing the said source item. For example, each intermediary node may be displaced in a layer of the data structure with respect to the root node that indicates at least a level of reliability of the content item represented by each intermediary node. Content items having confidence scores similar to those of a recently added node or content item may become child nodes for such intermediary node. The content items associated with or represented by leaf nodes (bottommost level of the data structure) may be deemed the most irrelevant or most unreliable out of all content items represented in the data structure.

In some embodiments, a displacement of each of the plurality of intermediary nodes may be determined with respect to the root node. For example, the displacement of each of the plurality of intermediary nodes may correlate to the confidence score of each of the plurality of content items and the new content item represented by each of the plurality of intermediary nodes. In some embodiments, a rank may be assigned to each level of nodes to reflect their level of reliability with respect to the total data structure. In some embodiments, the rank may be determined based on the level or layer of the intermediary node representing the content item. For example, the closer the content item is to the first layer or an upper layer of a tree structure, the more reliable it is determined to be. In some embodiments, each node in a tree may have an associated depth which indicates how far away from nodes in the upper layers it is, for example, measured by a number of links between each node.

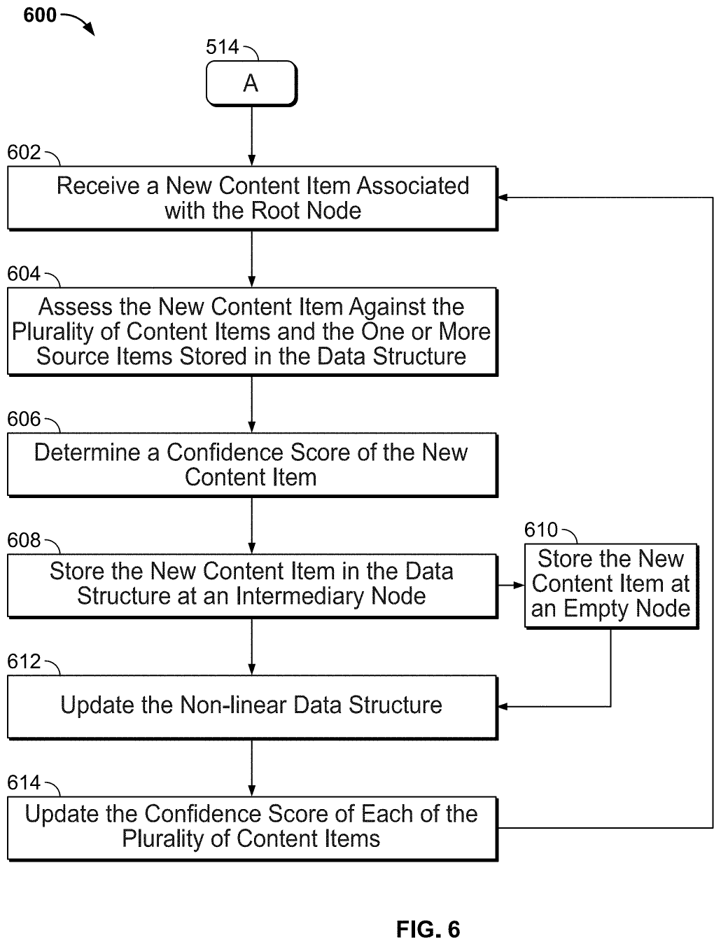

FIG. 6 is a flowchart of illustrative steps involved in updating a data structure and determining confidence scores for new or additional content items associated with the data structure in a way that indicates the new content item's reliability based on various source content items and/or content items currently represented in the data structure, in accordance with some embodiments of the present disclosure. In addition, one or more steps of process 600 may be incorporated into or combined with one or more steps of any other process or embodiment disclosed herein.

At step 602, the system receives a new content item associated with the root node. In some embodiments, once a non-linear data structure, as described above, has been created, the data structure may continue to receive new content items associated with the category; event or topic that is assigned to the root node; enable scoring of each of the new content items; and further update the data structure to become more accurate over time.

At step 604, the system assesses the new content item against the content items and the source items already represented in the data structure by nodes. In some embodiments, the new content item may be scored with respect to the source content items. Alternatively, the new content item may be assessed against and scored with respect to both the source content items and the plurality of content items currently stored in the database and represented in the data structure. In this way, the data structure may be refined by further updating confidence scores based on additional peripheral news and useful insights over time.

At step 606, the system determines a confidence score of the new content item. In example embodiments, a confidence score may be determined for new content items based on the assessment of the new content item against the source content items and content items already classified by the system. The confidence score of the new content item may be indicative of the new content item's reliability with respect to the plurality of content items and the one or more source items present in the data structure.

At step 608, the system stores the new content item to be represented by an intermediary node and represented in the data structure. In some embodiments, the new content item may be represented by one of the plurality of intermediary nodes based on the confidence score determined for the new content item. In some embodiments, the new content item may replace a content item already represented in the data structure with an intermediary node, for example. In some embodiments, the new content item may replace a source item already represented in the data structure and represented by a source node, for example. For example, in some embodiments, the new content item may be a content item generated from the same source of an initially determined source item. For example, over time, the source may generate the new content item to correct one or more facts presented in the initial source content item. In such cases, the new content item may be represented in the data structure to be associated with the source node of the initial source item, and may be represented by the source node thereby replacing the source item with the new and more reliable content item, for example, based on the confidence score of the new content item. The source item may subsequently be “downgraded” to a child node of the source item, for example.

At step 610, the system optionally stores the new content item to be represented by an empty node. In some embodiments, where a data structure does not yet include valid nodes, i.e., has no represented content item, in any of the layers of the data structure, empty nodes may be used to represent such invalid nodes, which may later be used to represent articles that have the rank or confidence level that should be represented or associated with a specific layer of the data structure. Thus, in some embodiments, the new content item may be represented by an intermediary node that was initially an empty node.

At step 612, the system updates the non-linear data structure. In some embodiments, the non-linear data structure may be updated upon determining a new entry of a content item into a database of content items, for example, representing content items from sources registered on the database and/or publicly available online content. For example, the ranking of news sources can change over time as they establish a higher trust factor. For example, an outlet in the “unreliable” classification may eventually move to the “reliable” classification for a particular topic if the outlet's reporting on the topic is consistent with the reporting on the same topic from sources that are considered to be trustworthy.

At step 614, the system updates the confidence score of each content item. In some embodiments, updating the non-linear data structure involves updating the confidence score of each content item present in the data structure. In some embodiments, the confidence score of any given content item represented in the data structure may increase or decrease over time and be scored or weighted accordingly. For example, content items may be labelled only when there are sufficient numbers of highly reliable content items, highly unreliable content items and neutral content items, for example, in order to score content items more accurately.

In general, every content item can be classified into a category, such as politics, sports, business, tech, etc. Content items, such as articles, may cover a breaking news story about a topic that is already verified, for example, an event such as a previous presidential election. Alternatively, content items may cover a developing story or a trending topic, or an event that is actively being covered, which may not be directly related to other previously published content items, for example, or is limited in reference content items to refer to. For example, a developing story may relate to an ongoing epidemic. In some embodiments, a topic can be considered verified if it originates from at least one trusted source. For example, a news outlet such as TMZ is known for breaking stories related to celebrities, e.g., deaths, engagements, divorces, etc. In some embodiments, the content item may be associated with a past event or an event currently in progress. For example, a past event may relate to one or more previous presidential elections, and an event in progress may relate to a current presidential election.

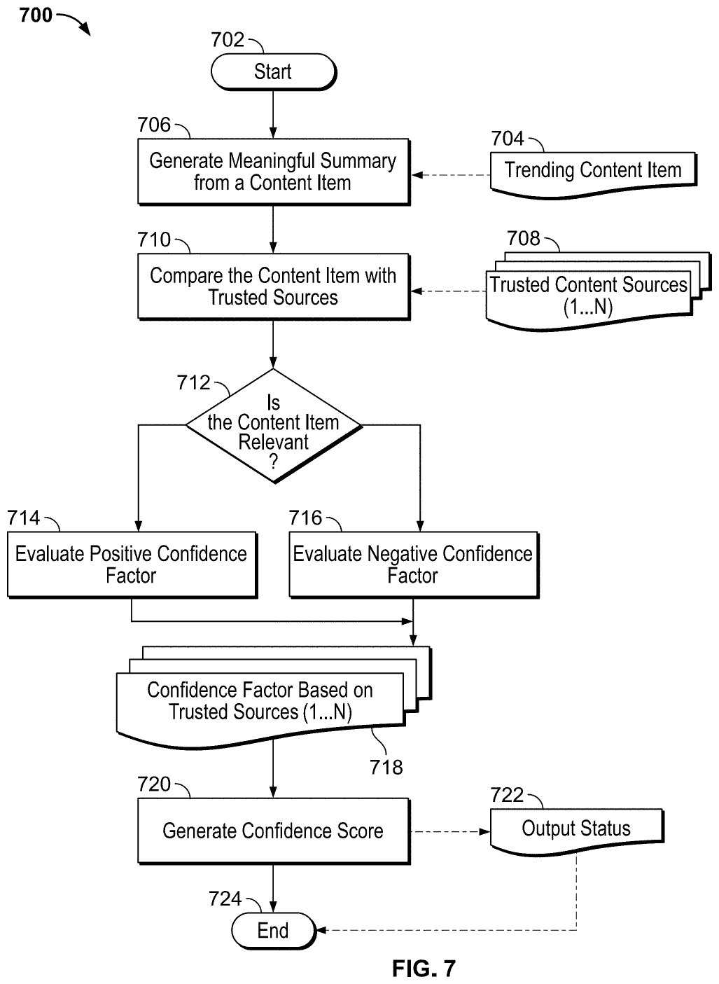

FIG. 7 is a flowchart of illustrative steps of an example implementation of some embodiments of the present disclosure for determining a confidence scoring process for a content item as part of a trending topic or event. In addition, one or more steps of process 700 may be incorporated into or combined with one or more steps of any other process or embodiment disclosed herein.

At step 702, the system starts the confidence scoring process for a content item as part of a trending topic or event.

At steps 704 and 706, the system generates a meaningful summary, e.g., based on any of the above classification methods, of a trending content item received by the system. In some embodiments, it may be determined whether the content item relates to a verified or trending topic or event. For example, a verified topic may be a topic the details of which are known to be accurate or justified, and a trending topic may relate to a topic that is currently popular, e.g., based on the number of total views in relation to the trending topic, or widely discussed, e.g., on social media websites.

At steps 708 and 710, the system compares and assesses the content item against source items retrieved from one or more trusted sources.

At step 712, the system determines the content item's relevance to a source item, e.g., by determining whether the content item relates to a root node of a data structure. In some embodiments, content items targeting an event that is currently in progress, e.g., content items relating to an election during an election month, may rely on previous articles relating to the event in progress or previous articles associated with previously verified events relating to the event in progress with high scores to compute a more robust confidence score.

At step 714, the system may evaluate a positive confidence factor indicating a high level of relevance to the trusted sources and, at step 716, the system may evaluate a negative confidence factor indicating a low level of relevance associated with the trusted sources.

At step 718, the system receives the positive confidence factor and negative confidence factor for the content item to generate a total confidence factor based on the trusted sources.

At step 720, the system generates a confidence score for the trending content item. The process determines the confidence score of the new content item. The process assesses the new content item against other content items and the source items present in the data structure, as described above in relation to FIG. 6.

At step 722, the system may, in some embodiments, output a status of the content item for a user consuming the content item. In some embodiments, content items may be further assigned a status indicative of whether the content item should be labelled as “real” or “fake,” for example. In other examples, the status may be indicative of whether the content item is “factually correct” or “factually incorrect,” “disputed or undisputed,” or “relevant or irrelevant.”

At step 724, the system may terminate the process for the assessed content item.

In some embodiments, the status for each content item may be updated upon entry of new or additional content items into the data structure. It will be appreciated that the labelling of content items may cause further divisions of labels. For example, a content item may be labelled as any one of “disputed,” “undisputed,” “heavily disputed,” “moderately disputed,” etc.

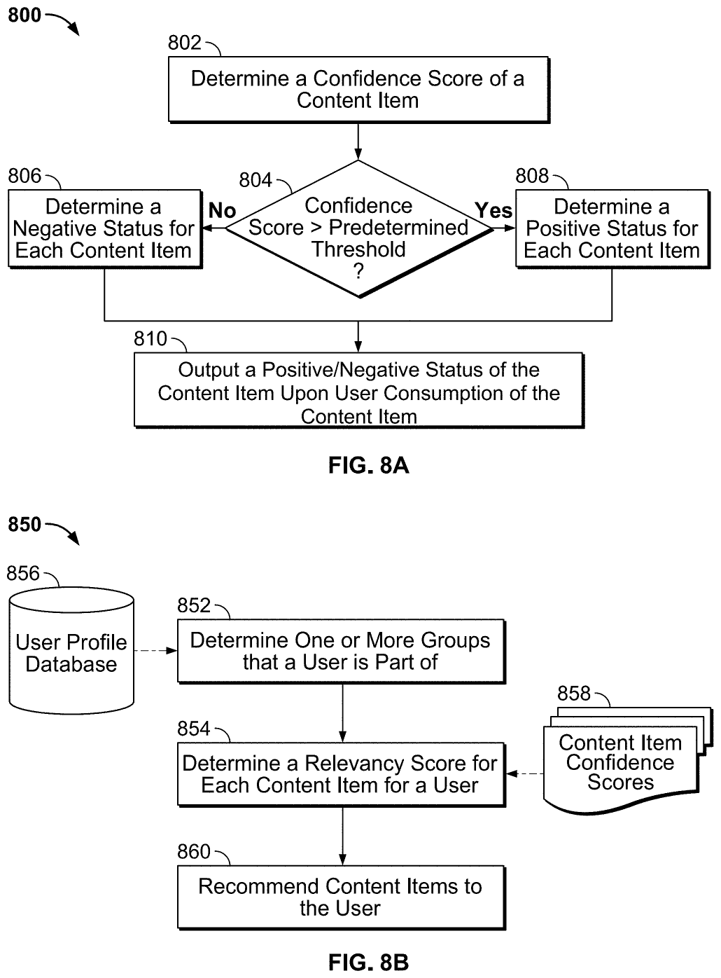

FIG. 8A is a flowchart of illustrative steps involved in determining the status of content items based on their confidence scores and a predetermined threshold setting suitable for labelling the content item with a negative or a positive status, in accordance with some embodiments of the present disclosure. In addition, one or more steps of process 800 may be incorporated into or combined with one or more steps of any other process or embodiment disclosed herein.

At step 802, the system determines a confidence score of a content item and, at step 804, the system determines whether the confidence score is above the predetermined threshold.

At step 806, the system may determine a negative status for each content item or, at step 808, a positive status for each content item. For example, content items may be determined to be above or below a predetermined threshold score. Furthermore, it may be predetermined that a content item can be determined to be reliable only if the confidence score is above 70%, for example, in order to sufficiently filter out content items showing signs of unreliability. Furthermore, in some embodiments, the positive status and the negative status may be further divided into highly positive, highly negative, moderately positive, and moderately negative status, for example.

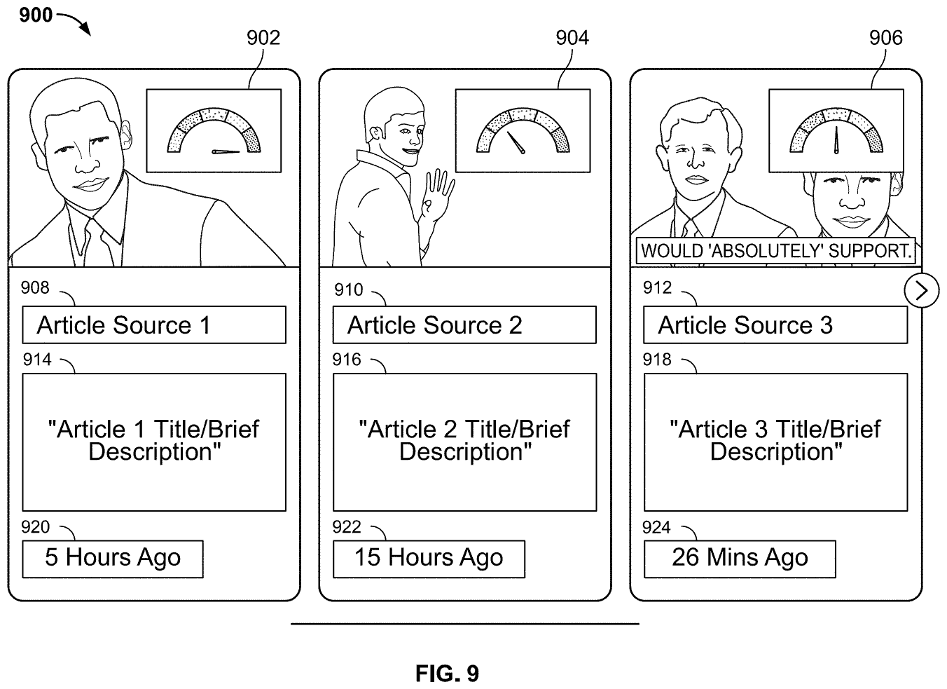

At step 810, the system may output a positive/negative status of the content item upon user consumption of the content item. In some embodiments, a content item's status may be output by displaying, for presentation to a user on a visual display, the status of the content item using a visual indicator, which will be described further with respect to FIG. 9, to notify the user that the merits of a content item are currently being disputed or the content item has been verified to be fake news, for example.

FIG. 8B is a flowchart of illustrative steps involved in recommending content items to users based on knowledge of the user, such as any groups associated with the user, and the determined confidence scores of the content items. In addition, one or more steps of process 850 may be incorporated into or combined with one or more steps of any other process or embodiment disclosed herein.

At step 852, the system determines one or more groups or syndicates comprising the user. For example, one or more syndicates of the user may be determined based on at least one of: a location of the user, an online community, an online platform, a social media platform, a friendship group, a workplace group, one or more content items viewed by the user, one or more content items liked by the user, and/or one or more content sources followed by the user. The user's associated groups may be determined using a user profile database 856.

At step 854, the system determines a relevancy score, otherwise described as a secondary score, for each content item for a user based on the groups associated with the user, the user profile database 856 and the generated confidence scores of each content item 858. For example, the relevancy score of a particular content item may be determined for a user based on their inclusion or activity within a certain group.

At step 860, the system may recommend one or more content items to be provided to the user for consumption based on the relevancy score of each content item. In some embodiments, the user may be recommended content items based on both the confidence scores and relevancy scores of content items within the system's database, for example. For example, users who follow a specific channel or source that published an article that was ranked highly in terms of reliability may be recommended content associated with that channel or source based on the relevancy score for the user. This may allow followers of groups and users, or a group of followers or users, to view or be recommended content items from sources that they follow, thereby respecting personal views and preferences while providing an informative mechanism to limit or restrict the spread of false or unreliable information.

In some embodiments, users may also be provided with the option to retrieve a list of content items and/or links to the content items that are ranked highly with respect to an event or topic that the user wishes to follow or is currently following. In this way, the user may consume media content that continues to match the user's interest, preferences and personal views while providing a mechanism that allows the user to gain further insight into the topic or event of interest.

FIG. 9 shows an illustrative diagram of an example user interface comprising a visual indicator representing the status of content items, in accordance with some embodiments of the present disclosure.

In some embodiments, a visual indicator, such as visual indicators 902, 904, 906, may be displayed to notify the user that the merits of a content item are currently being disputed or the content item has been verified to be fake news. By way of example, FIG. 9 shows the status of three articles from article sources 908, 910, 912, having article titles/brief descriptions 914, 916, 918 and upload times 920, 922, 924, for example.

In an example, if a user is watching a less reliable content source online using a media guidance application on a media device, a notification may be displayed for the user during the consumption of media content. For example, upon determining that the content source is expressly encouraging the spread of fake news, the media guidance application may show a notification, e.g., a pop-up notification, with a visual indicator or message to notify the user that the contents of the content source may be unreliable.

Some embodiments of the present disclosure may be integrated into any system or platform where content items are shared among users. For example, embodiments described herein may be integrated into social media platforms where the sharing of content items is vast and uncontrollable. Embodiments described herein may also be integrated into chatting applications for a more informative discussion between users within the chat. Additionally, or alternatively, a system comprising embodiments described herein may be integrated into one or more user devices or one or more media guidance applications, for example.

In some embodiments, one or more of the data structures may be prioritized over another. For example, it may be that a particular event or topic has lost the interest of media content consumers and therefore is updated less often relative to trending topics or events. Furthermore, in some embodiments, if a data structure does not carry any source items of high reliability, for example, that data structure may be assigned a low priority for updating or deemed irrelevant or factually incorrect over time.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes.

Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It will be appreciated that the media guidance application may perform one or more of the functions described above simultaneously. It should also be noted, the systems and/or methods described above may be applied to, or used in accordance with, other systems and/or methods. Additionally any of the steps in said processes can be performed in any order, can be omitted, and/or can be combined with any of the steps from any other process.

While some portions of this disclosure may make reference to “convention,” any such reference is merely for the purpose of providing context to the invention(s) of the instant disclosure, and does not form any admission as to what constitutes the state of the art.

1. A method for determining the reliability of online content items using a non-linear data structure, the method comprising:
determining a root node of the non-linear data structure, wherein the root node comprises a content category and/or an event;
receiving one or more source items and a plurality of content items for the non-linear data structure associated with the root node;
determining a classification of each of the one or more source items, wherein the classification is based at least on a reliability of the one or more source items;
storing each of the one or more source items to be represented by one of a plurality of source nodes of the non-linear data structure;
assessing each of the plurality of content items against the one or more source items stored for the non-linear data structure;
determining a confidence score of each of the plurality of content items based on the assessment, wherein the confidence score of each of the plurality of content items is indicative of each of the plurality of content item's reliability with respect to at least the one or more source items; and
storing each of the plurality of content items to be represented by one of a plurality of intermediary nodes of the non-linear data structure based on the confidence score of each of the plurality of content items, wherein each of the plurality of intermediary nodes are associated with one or more of the plurality of source nodes.

2. The method of claim 1, further comprising:
receiving a new content item associated with the root node;
assessing the new content item against the plurality of content items and the one or more source items stored for the non-linear data structure; and
determining a confidence score of the new content item based on the assessment, wherein the confidence score of the new content item is indicative of the new content item's reliability with respect to the plurality of content items and the one or more source items.

3. The method of claim 2, further comprising:
storing the new content item for the non-linear data structure to be represented by one of the plurality of intermediary nodes based on the confidence score of the new content item.

4. The method of claim 3, wherein at least one of the plurality of intermediary nodes is an empty node.

5. The method of claim 4, wherein the step of storing the new content item comprises storing the new content item to be represented by the empty node.

6. The method of claim 3, further comprising:
updating the non-linear data structure upon storing the new content item.

7. The method of claim 6, wherein the step of updating the non-linear data structure comprises:
updating the confidence score of each of the plurality of content items, wherein the updated confidence score is indicative of each of the plurality of content item's reliability with respect to at least the one or more source items and the new content item stored for the non-linear data structure.

8. The method of claim 3, further comprising:
determining a displacement of each of the plurality of intermediary nodes with respect to the root node.

9. The method of claim 8, wherein the displacement of each of the plurality of intermediary nodes correlates to the confidence score of each of the plurality of content items and the new content item associated with each of the plurality of intermediary nodes.

10. The method of claim 3, further comprising:
determining a relevancy score for a user consuming one or more of the plurality of content items and/or the new content item.

11. The method of claim 10, further comprising:
recommending one or more content items to the user based on the confidence score and/or relevancy score of each of the plurality of content items and the new content item.

12. The method of claim 10, further comprising:
determining one or more groups comprising the user, wherein the relevancy score for the user is determined based on the one or more groups comprising the user.

13. The method of claim 12, wherein the one or more groups comprising the user is determined based on at least one of: a location of the user, an online community; an online platform; a social media platform; a friendship group; a workplace group; one or more content items viewed by the user; one or more content items liked by the user; and/or one or more content sources followed by the user.

14. The method of claim 3, further comprising:
determining a status to each of the plurality of content items and the new content item, wherein the status is indicative of any of: true or false, factually correct or factually incorrect; disputed or undisputed; or relevant or irrelevant.

15. The method of claim 14, wherein the step of determining the status further comprises:
determining whether the confidence score of each of the plurality of content items and the new content item is above or below a predetermined threshold score.

16. The method of claim 3, further comprising:
notifying the user consuming one or more of the plurality of content items and/or the new content item of the reliability of the one or more of the plurality of content items and/or the new content item using a notification for display.

17. The method of claim 16, wherein the notification comprises an indication of the confidence score of each of the plurality of content items and/or the new content item.

18. The method of claim 1, wherein the one or more source content items comprise content items from at least one of: a broadcast; a news provider; an online news platform; an online blog; a social media platform; and/or a group within the social media platform.

19. The method of claim 1, wherein the classification of each of the one or more source items is further based on at least one of: a popularity; a quality; a level of professionalism; researched public sentiment; a number of views; a number of followers; a number of likes; a source; an author; a historical classification of the source; a historical classification of the author; one or more similar source items; one or more associated source items; and/or historically classified source items.

20. The method of claim 1, wherein the confidence score of each of the plurality of content items and the confidence score of the new content item is further based on at least one of: a popularity; a quality; a level of professionalism; researched public sentiment; a number of views; a number of followers; a number of likes; a source; an author; a historical classification of the source; a historical classification of the author; one or more similar source items; one or more associated source items; confidence scores of one or more associated content items; a location of its viewers; a link; a reference; and/or a relevance to a verified content item.

21.-60. (canceled)
